(19) United States
(12) Patent Application Publication
(10) Pub. No.: US 2016/0246387 A1
(43) Pub. Date: Aug. 25, 2016

(54) Electronic Device, Operation Control Method, and Computer Program Product

(71) Applicants: Kabushiki Kaisha Toshiba, Tokyo (JP); Toshiba Lifestyle Products & Services Corporation, Tokyo (JP)

(72) Inventor: Yusuke Ikeda, Akishima (JP)

(73) Assignees: Kabushiki Kaisha Toshiba, Tokyo (JP); Toshiba Lifestyle Products & Services Corporation, Tokyo (JP)

(21) Appl. No.: 15/141,730

(22) Filed: Apr. 28, 2016

Related U.S. Application Data
(63) Continuation of application No. PCT/JP2013/079466, filed on Oct. 30, 2013.

(51) Int. Cl. G06F 3/038; G09G 5/08; G06F 3/01; G06F 3/0346; G06F 3/02

(52) U.S. Cl. CPC G06F 3/038; G06F 3/0346; G06F 3/02; G06F 3/017; G09G 5/08

(57) ABSTRACT

According to one embodiment, an electronic device includes a receiver, a first determining module, a second determining module, a calculator, and a controller. The receiver receives operation information at a regular time interval. The first determining module determines, when an operating module is pressed based on click information, whether or not an amount of movement in the received operation information is equal to or greater than a first threshold value. The second determining module determines, when the amount of movement is equal to or greater than the first threshold value, whether or not a predetermined period of time elapses from an initial press to the operating module. The calculator determines, when the predetermined period of time has elapsed from the initial press to the operating module, that a swipe operation has been performed with the operating module and calculates an amount of movement of a pointer to be a greater value than an amount of movement in a drag operation.

### CROSS-REFERENCE TO RELATED APPLICATIONS

This application is a continuation of International Application No. PCT/JP2013/079466, filed on Oct. 30, 2013, the entire contents of which are incorporated herein by reference.

### FIELD

Embodiments described herein relate generally to an electronic device, an operation control method, and a computer program product.

### BACKGROUND

Typically, along with the advance of the computer technology, programs and services has become available on various electronic devices.

In order to use a program or a service on an electronic device, it is necessary to provide a user interface suitable for the concerned program or service. In this regard, for the purpose of allowing a user to perform various operations with one hand, a pointing device has been proposed, which can implement a stick operation and a click operation of a pointer with a single operating module.

However, it is difficult to implement a so-called swipe operation with a conventional pointing device, in which the user touches the screen of a touch-sensitive panel with a finger and slides the finger (runs the finger) in a particular direction, that is, the user drags a finger over a certain distance in a short period of time.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external perspective view of a television broadcast display device according to a first embodiment;

FIG. 2 is an exemplary external front view of a remote controller according to the first embodiment;

FIG. 3 is an exemplary cross-sectional view of the vicinity of a cursor key of the remote controller according to the first embodiment;

FIG. 4 is an exemplary block diagram illustrating an overall configuration of the television broadcast display device according to the first embodiment;

FIG. 5 is an exemplary block diagram illustrating a functional configuration of a controller of the television broadcast display device according to the first embodiment;

FIG. 6 is an exemplary diagram illustrating operation information according to the first embodiment;

FIGS. 7 and 8 are exemplary flowcharts of a sequence of an operation control process according to the first embodiment;

FIG. 9 is an exemplary diagram illustrating the relationship among operation information, dead threshold value, intermediate data, and pointer movement amount and click bit according to the first embodiment;

FIG. 10 is an exemplary block diagram illustrating a functional configuration of a controller of a television broadcast display device according to a second embodiment;

FIG. 11 is an exemplary diagram illustrating operation information and divided data according to the second embodiment;

FIG. 12 is an exemplary flowchart of a sequence an operation control process according to the second embodiment; and

FIG. 13 is an exemplary flowchart of a sequence of an operation information dividing process according to the second embodiment.

### DETAILED DESCRIPTION

In general, according to one embodiment, an electronic device comprises a receiver, a first determining module, a second determining module, a calculator, and a controller. The receiver receives operation information at a regular time interval. The operation information includes an amount of movement by an operation of an operating module in association with click information. The click information indicates that the operating module is pressed. The first determining module determines, when the operating module is pressed based on the click information, whether or not the amount of movement in the received operation information is equal to or greater than a first threshold value. The second determining module determines, when the amount of movement is equal to or greater than the first threshold value, whether or not a predetermined period of time elapses from an initial press to the operating module. The calculator determines, when the predetermined period of time has elapsed from the initial press to the operating module, that a swipe operation has been performed with the operating module and calculates an amount of movement of a pointer to be a greater value than an amount of movement in a drag operation. The controller controls movement of the pointer based on the calculated amount of movement of the pointer and the click information.

The following embodiments will describe examples of a television broadcast display device to which an electronic device is applied. However, in the embodiments, the electronic device is not limited to a television broadcast display device, and can alternatively be implemented in any electronic device that performs operations based on cursor operations and click operations.

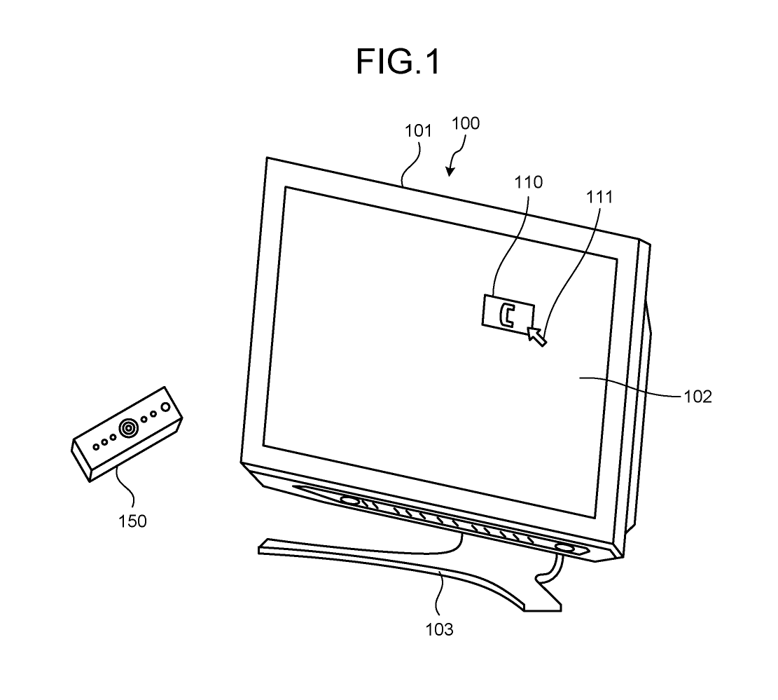

As illustrated in FIG. 1, a television broadcast display device 100 according to a first embodiment is configured of an LCD (Liquid Crystal Display) and includes a housing 101 that is supported by a support 103 and that has a rectangular external appearance in the front view, and an image display panel 102 that is capable of displaying a variety of information such as still images and moving images.

Herein, operation information on an operation with a remote controller 150 is sent to the television broadcast display device via infrared communication. As a result, a cursor 111, which is displayed on the image display panel 102 of the television broadcast display device 100, becomes operable. Using the remote controller 150 according to the first embodiment, stick operations and click operations of the cursor 111 as well as dragging an icon 110 and swipes on the screen are feasible.

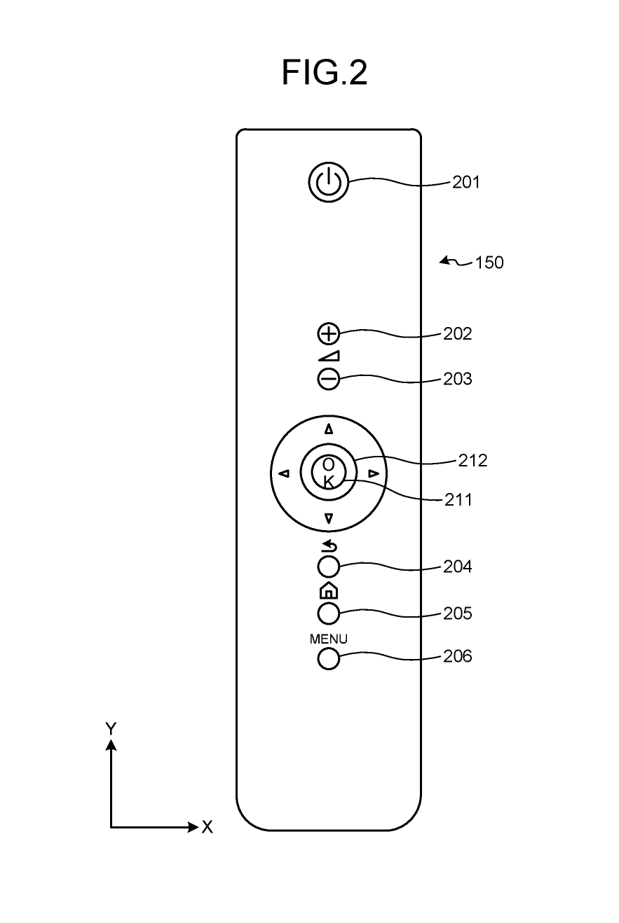

As illustrated in FIG. 2, the remote controller 150 includes a power button 201 for switching ON and OFF the television broadcast display device 100; volume buttons 202 and 203 for varying audio volume; a return button 204; a home button 205; a menu button 206; and a stick 211.

The television broadcast display device 100 according to the first embodiment is what is called a smart television on which programs and services provided via the Internet are implementable in addition to broadcasting programs provided from broadcast waves. The home button 205 is used to return to the home screen of the smart television. The return button 204 is used to return to a previous screen. The menu button 206 is used to display a menu screen.

The stick 211 is used for selecting various programs and services from the menu screen displayed on the television broadcast display device 100. The stick 211 can be pressed as a button to perform a click operation, and can be moved vertically and horizontally (in X-Y planar directions) within an operation area 212. In the first embodiment, the operation in which the stick 211 is moved vertically and horizontally (in the X-Y planar directions) is referred to as a stick operation. In the first embodiment, by a stick operation, the cursor 111 can be moved. Moreover, during a click, a stick operation to the cursor 111, in other words, a drag operation can also be performed. Furthermore, in the first embodiment, a user's operation to click and promptly move the stick 211 in a particular direction before releasing the stick 211 corresponds to a swipe operation on the touch-sensitive panel in which a user touches the screen with a finger (runs a finger) and slides the finger in a particular direction.

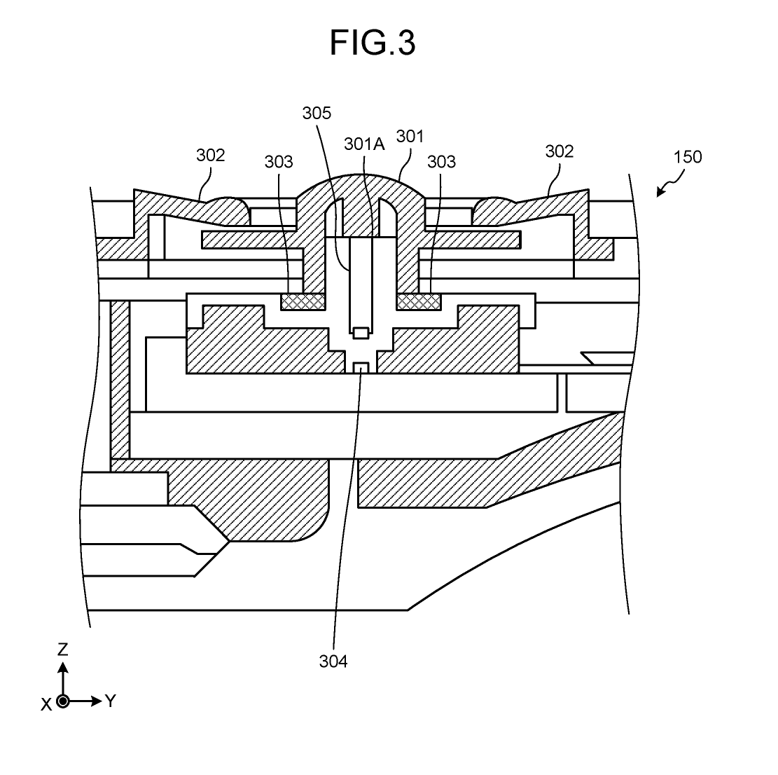

As illustrated in the cross-sectional diagram in FIG. 3, the stick 211 includes a slide knob 301, a ring cover 302, an elastic member 303, a click receiving button 304, a stick member 305. By pressing down the slide knob 301, the elastic member 303 is pressed and a face 301A presses the stick member 305 (in the negative direction along the Z axis). As a result, the click receiving button 304 is pressed. In response to the press onto the click receiving button 304, the remote controller 150 sends a click bit ON to the television broadcast display device 100. In response to no press to the click receiving button 304, the remote controller 150 sends a click bit OFF to the television broadcast display device 100.

Moreover, the slide knob 301 is movable in the X-Y planar directions only within the operation area not blocked by the ring cover 302. Along with the motion of the slide knob 301 in the X-Y planar directions, the remote controller 150 uses two linear variable resisters (not illustrated) to detect position coordinates in the x-axis direction from a resistance value in the x-axis direction and detect position coordinates in the y-axis direction from a resistance value in the y-axis direction, and sends the position coordinates in the x-axis direction as the amount of movement in the x-axis direction and the position coordinates in the y-axis direction as the amount of movement in the y-axis direction to the television broadcast display device 100 at a regular time interval of 100 ms, for example. Thereby, a stick operation can be implemented.

The remote controller 150 according to the first embodiment sends, to the television broadcast display device 100, at the abovementioned regular time interval, operation information including the amounts of movement of the stick 211 in the x-axis direction and the y-axis direction in association with the click bits. In the following, the amounts of movement of the stick 211 in the x-axis direction and the y-axis direction are referred to as operation data, while the data that represents operation data associated with the click bits and that is sent from the remote controller 150 to the television broadcast display device 100 is referred to as operation information.

Given below is the explanation of the television broadcast display device 100 according to the first embodiment. The television broadcast display device 100 is a stationary image display device that receives airwaves of digital broadcasting and retrieves image signals from the received airwaves to display images on programs.

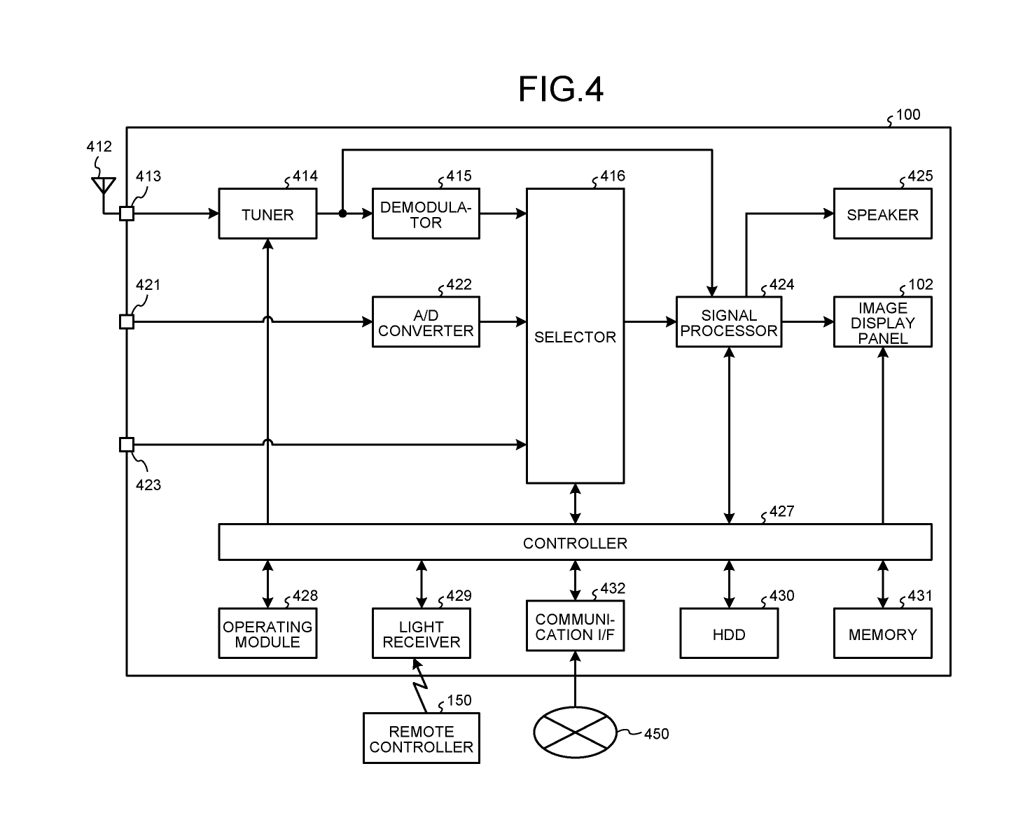

As illustrated in FIG. 4, the television broadcast display device 100 includes an antenna 412, an input terminal 413, a tuner 414, and a demodulator 415. The antenna 412 captures the airwaves of a digital broadcast and sends broadcast signals of the airwaves to the tuner 414 via the input terminal 413.

The tuner 414 tunes into the broadcast signals of a desired channel from input broadcast signals of the digital broadcast and supplies the broadcast signals to the demodulator 415. The demodulator 415 demodulates the broadcast signals to obtain digital image signals and audio signals, and sends the demodulated signals to a later-described selector 416.

Meanwhile, the television broadcast display device 100 also includes input terminals 421 and 423, an A/D converter 422, a signal processor 424, a speaker 425, and an image display panel 426.

The input terminal 421 receives analog image signals and analog audio signals from outside, while the input terminal 423 receives digital image signals and digital audio signals from outside. The A/D converter 422 receives the analog image signals and the analog audio signals from the input terminal 421, converts them into digital signals, and sends the digital signals to the selector 416.

The selector 416 selects one of the digital image signals and the digital audio signals from the demodulator 415, the A/D converter 422, and the input terminal 423, and supplies the selected signals to the signal processor 424.

The signal processor 424 performs predetermined signal processing and scaling to the input image signal and supplies the processed image signal to the image display panel 426. Moreover, the signal processor 424 performs predetermined signal processing to the input digital audio signal, converts the digital audio signal into an analog audio signal, and outputs the analog audio signal to the speaker 425. The television broadcast display device 100 includes at least a TS demultiplexer and a MPEG decoder, and signals are decoded by the MPEG decoder and input to the signal processor 424.

Moreover, the signal processor 424 generates OSD (On Screen Display) signals for display on the image display panel 426.

The speaker 425 receives the audio signals from the signal processor 424 and outputs an audio based on the audio signals.

The image display panel 426 is configured of a flat panel display such as a liquid crystal display or a plasma display. The image display panel 426 displays an image based on the image signals supplied from the signal processor 424.

The television broadcast display device 100 further includes a controller 427, an operating module 428, a light receiver 429, an HDD (Hard Disk Drive) 430, a memory 431, and a communication I/F 432.

The controller 427 generally controls various operations in the television broadcast display device 100. The controller 427 is a microprocessor that incorporates a CPU (Central Processing module) that receives the operation information from the operating module 428 and the operation information from the remote controller 150 via the light receiver 429, to control the individual elements according to the operation information. The light receiver 429 according to the first embodiment receives infrared light from the remote controller 150.

Herein, the controller 427 makes use of the memory 431. The memory 431 mainly includes a ROM (Read Only Memory) that stores a control program to be executed by the CPU incorporated in the controller 427, a RAM (Random Access Memory) that provides a work area for the CPU, and a nonvolatile memory that stores a variety of configuration information and control information.

The HDD 430 functions as a recorder on which digital image signals and digital audio signals selected by the selector 416 are recorded. Provided with the HDD 430, the television broadcast display device 100 can record the digital image signals and the digital audio signals selected by the selector 416 on the HDD 430. Moreover, the television broadcast display device 100 can reproduce images and audio from the digital image signals and the digital audio signals recorded on the HDD 430.

The communication I/F 432 is connected to various communication devices (such as a server) via a public network 450 and can receive programs and services available on the television broadcast display device 100 as well as can send a variety of information.

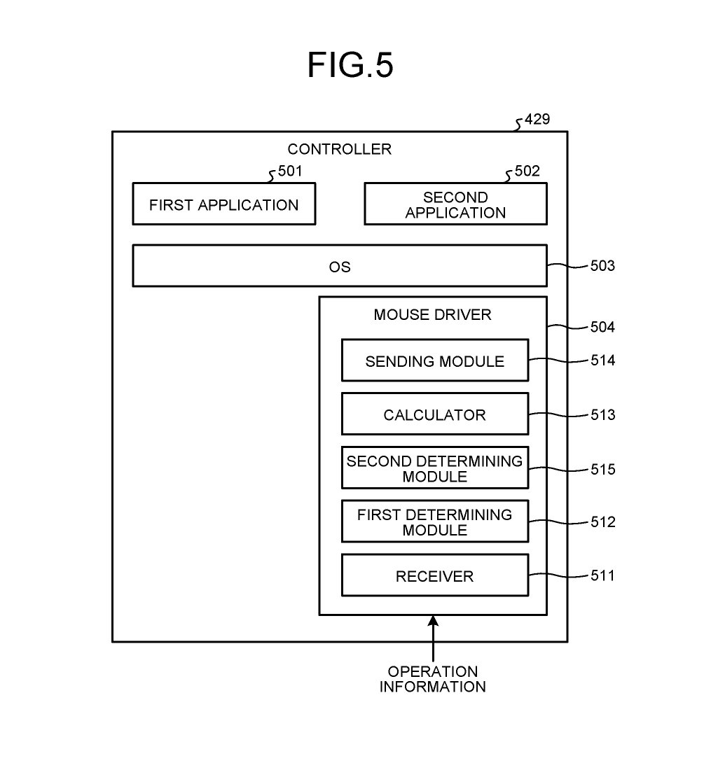

Given below is the explanation of a functional configuration of the controller 427. As illustrated in FIG. 5, the controller 427 according to the first embodiment implements a first application 501, a second application 502, an operating system 503, and a mouse driver 504.

The mouse driver 504 receives the operation information from the light receiver 429 and transfers it to the operating system 503 (hereinafter, referred to as OS 503) as the amount of movement of the pointer of the cursor 111 (hereinafter, referred to as pointer movement amount”) and a click operation. As illustrated in FIG. 5, the mouse driver includes a receiver 511, a first determining module 512, a second determining module 515, a calculator 513, and a sending module 514.

The receiver 511 receives operation information from the remote controller 150 at a regular time interval via the light receiver 429. As described earlier, the operation information contains operation data (x, y) and a click bit and is expressed as (x, y, click bit). Herein, x represents the amount of movement of the stick 211 in the x-axis direction, and y represents the amount of movement of the stick 211 in the y-axis direction. The click bit is set to either ON or OFF, as described earlier. The regular time interval is set to 100 ms, for example. However, it should be not limited thereto. The receiver 511 can be configured to receive the operation information from the operating module 428.

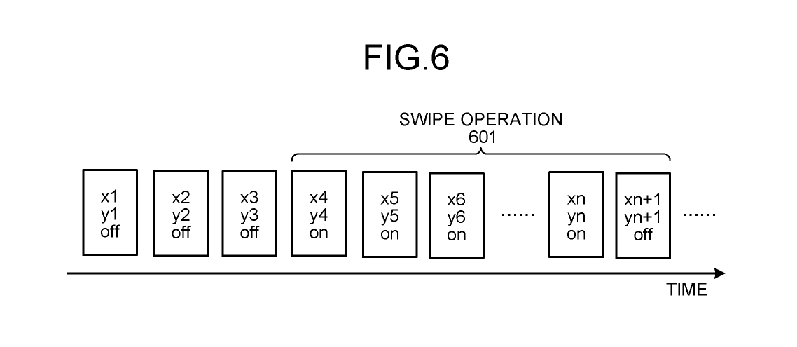

FIG. 6 illustrates an example of the operation information. As illustrated in FIG. 6, the receiver 511 receives, at the regular time interval, operation information on the stick 211 including the amount of movement in the x-axis direction (for example, x1, x2, . . . ), the amount of movement in the y-axis direction (for example, y1, y2, . . . ), and a click bit in association with one another.

When the click bit contained in the operation information received by the receiver 511 indicates ON, the first determining module 512 determines whether or not the operation data, that is, the amount of movement contained in the received operation information is equal to greater than a first dead threshold value. On the other hand, when the click bit contained in the operation information received by the receiver 511 indicates OFF, the first determining module 512 determines whether or not the operation data, that is, the amount of movement contained in the received operation information is equal to greater than a second dead threshold value.

Herein, the first dead threshold value and the second dead threshold value represent threshold values for regarding a minute movement of the stick 211 as no movement of the pointer (cursor 111). In the first embodiment, with the click bit ON, that is, during a click operation, the first dead threshold value is greater than the second dead threshold value with the click bit OFF, that is, in no click operation. For example, the first dead threshold value can be set to 50 and the second dead threshold value can be set to 20. However, they should not be limited to such an example.

When the operation data in the operation information is equal to or greater than the first dead threshold value, the second determining module 515 determines whether or not a predetermined period of time elapses from a time at which the click bit in previously received operation information is determined to be ON, that is, from the first indication of the ON of the click bit in the operation information.

The calculator 513 calculates the pointer movement amount based on the operation data. More particularly, for each set of operation information, the calculator 513 multiplies the operation data (the amount of movement in the x-axis direction and the amount of movement in the y-axis direction) by a predetermined velocity parameter to calculate the pointer movement amount (the pointer movement amount in the x-axis direction and the pointer movement amount in the y-axis direction).

The calculator 513 considers the ON of the click bit determined by the second determining module 515 as a start of a swipe operation. Also, when the second determining module 515 determines the operation data to be equal to or greater than the first dead threshold value and that the predetermined period of time has not elapsed from the determination of the ON of the click bit in the previously received operation information, the calculator 513 identifies the execution of a swipe operation using the stick 211 of the remote controller 150.

Herein, the swipe operation generally refers to an operation in which the user touches the screen of the touch-sensitive panel with a finger and slides the finger (runs the finger) in a particular direction. In the first embodiment, a swipe operation with the stick 211 of the remote controller 150 is defined to be a user's operation to press and click the stick 211 and promptly move the clicked stick 211 in a predetermined distance in a short period of time, and then stop clicking the stick 211 and release the press.

FIG. 6 illustrates the example that the operation information denoted by a reference numeral 601 is of a swipe operation. Upon the determination of a swipe operation, the calculator 513 multiplies the operation data by the first velocity parameter and calculates the pointer (cursor 111) movement amount.

Meanwhile, when the second determining module 515 determines that the operation data is equal to or greater than the first dead threshold value but that the predetermined period of time has elapsed from the determination of the ON of the click bit in the previously received operation information, the calculator 513 determines that the swipe operation has been terminated and a normal drag operation has been performed using the stick 211 of the remote controller 150. Upon the determination of the drag operation, the calculator 513 multiples the operation data by a second velocity parameter smaller than the first velocity parameter to calculate the pointer movement amount, and returns the velocity parameter to the value prior to the execution of the swipe operation. Thus, in the swipe operation, the pointer movement amount calculated by the calculator 513 is greater than the pointer movement amount calculated in the drag operation.

When the first determining module 512 determines that the click bit in the operation information indicates OFF (including a case in which the click bit turns to OFF after the execution of the swipe operation is determined), the calculator 513 regards the OFF of the click bit as a normal cursor movement, that is, a stick operation with no clicks and multiplies the operation data by a third velocity parameter to calculate the pointer movement amount. Herein, the third velocity parameter is greater than the second velocity parameter and smaller than the first velocity parameter. Hence, when the click bit indicates OFF, that is, a stick operation with no press to the stick 211, the pointer moves at a faster speed than in the drag operation but moves at a slower speed than in the swipe operation.

In the first embodiment, after the elapse of the predetermined period of time since the determination of the ON of the click bit, the calculator 513 calculates the pointer movement amount for the drag operation by multiplying the operation data by the second velocity parameter. However, the present embodiment should not be limited thereto. Alternatively, the calculator can be configured to obtain the pointer movement amount by multiplying the operation data by the third velocity parameter in case of no click operation (OFF of the click bit) after the elapse of the predetermined period of time.

Meanwhile, when the first determining module 512 determines that the operation data is smaller than the first dead threshold value or the second dead threshold value, the calculator 513 determines no movement of the pointer (the cursor 111) and sets the pointer movement amount to zero.

For each set of operation information, the sending module 514 sequentially sends, to the OS 503, a pair of the pointer movement amount (the pointer movement amount in the x-axis direction and the pointer movement amount in the y-axis direction) and the click bit. The sending timing coincides with the regular time interval with which the operation information is received.

The OS 503 controls the entire television broadcast display device 100. The OS 503 receives the pointer movement amount and the click bit from the mouse driver 504 at the regular time interval as the interval of reception of the operation information. Moreover, the OS 503 performs a process in accordance with the received pointer movement amount and click bit. Furthermore, as necessary, the OS 503 sends the received pointer movement amount and click bit from the mouse driver 504 to the first application 501 and the second application 502. Herein, the OS 503 represents an example of a controller.

The first application 501 and the second application 502 represent programs that are executed on the OS 503 for the purpose of providing services to the users from the television broadcast display device 100. The first application 501 and the second application 502 receive the pointer movement amount and the click bit from the OS 503, and perform various kinds of processing according to the received pointer movement amount and click bit.

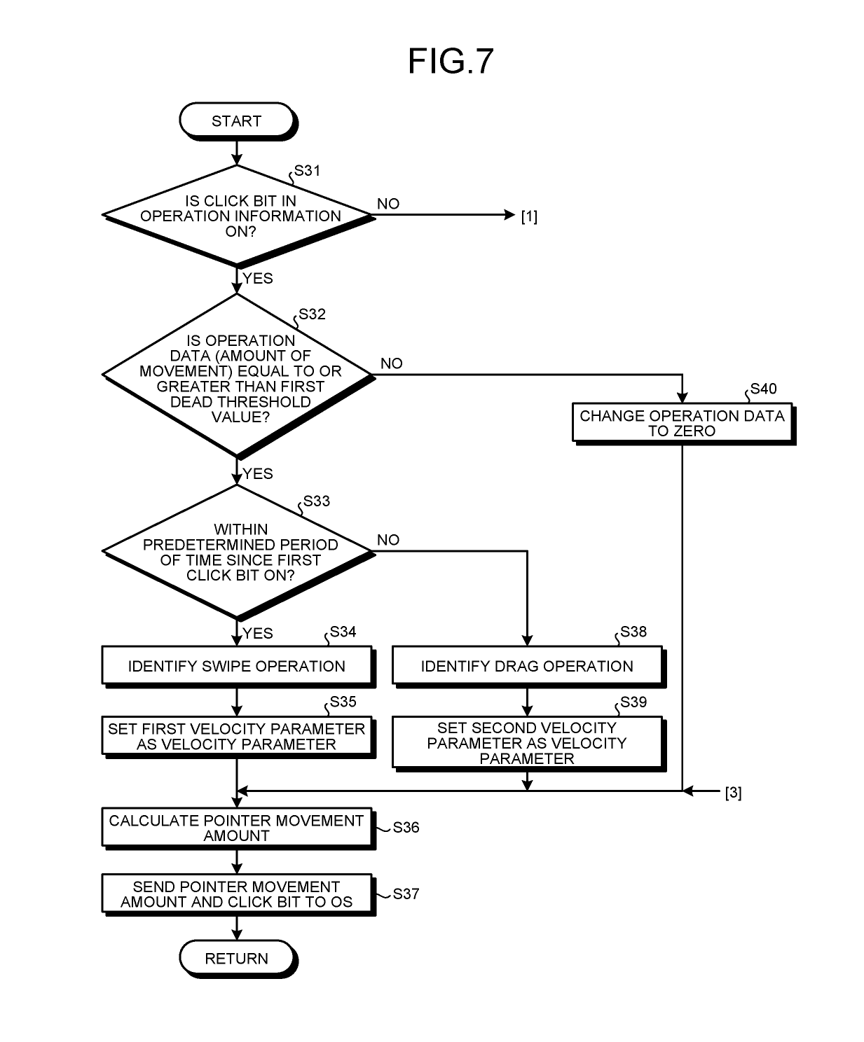

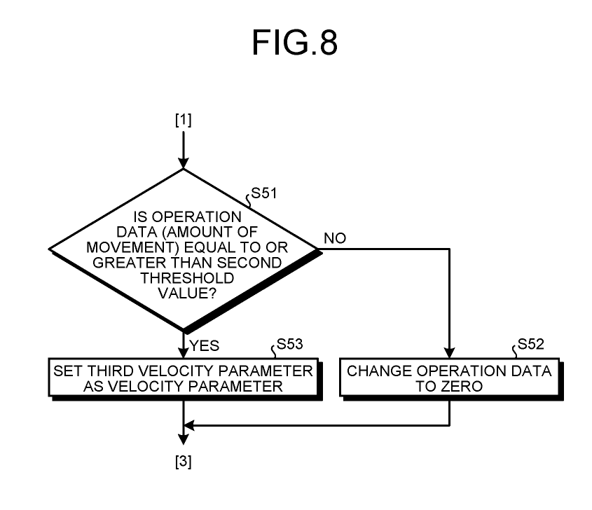

Explained below with reference to FIGS. 7 and 8 is the operation control process by the mouse driver 504 as configured above according to the first embodiment. Every time the receiver 511 of the mouse driver 504 receives operation information from the remote controller 150 at the regular time interval, the operations illustrated in FIGS. 7 and 8 are performed.

When the receiver 511 receives the operation information, the first determining module 512 determines whether or not the click bit in the operation information received by the receiver 511 indicates ON (Step S31). If the click bit is ON (Yes at Step S31), the first determining module 512 regards that as a start of a swipe operation and determines whether or not the operation data contained in the operation information is equal to or greater than the first dead threshold value (Step S32).

If the operation data is equal to or greater than the first dead value (Yes at Step S32), the second determining module 515 determines whether or not the predetermined period of time elapses since the determination of the ON of the click bit in the previously received operation information, that is, the first indication of the ON of the click bit in the operation information (Step S33).

If the predetermined period of time has not passed since the first indication of the ON of the click bit in the operation information (Yes at Step S33), the calculator 513 identifies a user's swipe operation with the remote controller 150 which has sent the operation information (Step S34). Subsequently, the calculator 513 sets the first velocity parameter as the velocity parameter (Step S35), and multiplies the operation data by the first velocity parameter to calculate the pointer movement amount (Step S36). The sending module 514 sends the pointer movement amount and the click bit to the OS 503 (Step S37).

Meanwhile, at Step S33, when the amount of movement is equal to or greater than the first dead threshold value but the predetermined period of time has elapsed since the first indication of the ON of the click bit in the operation information (No at Step S33), the calculator 513 identifies a user's termination of the swipe operation and drag operation with the remote controller 150 which has sent the operation information (Step S38). The calculator 513 sets the second velocity parameter for the drag operation as the velocity parameter (Step S39), and multiplies the operation data by the second velocity parameter to calculate the pointer movement amount (Step S36). Then, the sending module 514 sends the pointer movement amount and the click bit to the OS 503 (Step S37).

At Step S32, when the amount of movement is smaller than the first dead threshold value (No at Step S32), the calculator 513 changes the operation data to zero (i.e., the amount of movement in the x-axis direction to zero and the amount of movement in the y-axis direction to zero) (Step S40). Then, the calculator 513 calculates the pointer movement amount as zero (Step S36), and the sending module sends the pointer movement amount (=0) and the click bit to the OS 503 (Step S37).

At Step S31, when the click bit in the received operation information indicates OFF (No at Step S31), the first determining module 512 determines whether or not the operation data included in the received operation information is equal to or greater than the second dead threshold value (Step S51). If the operation data is equal to or greater than the second dead threshold value (Yes at Step S51), the calculator 513 sets the third velocity parameter as the velocity parameter (Step S53), and multiplies the operation data by the third velocity parameter to calculate the pointer movement amount (Step S36). Then, the sending module 514 sends the pointer movement amount and the click bit to the OS 503 (Step S37).

On the other hand, if the operation data is smaller than the second dead threshold value (No at Step S51), the calculator 513 changes the operation data to zero (i.e., the amount of movement in the x-axis direction to zero and the amount of movement in the y-axis direction to zero) (Step S52). Then, the calculator 513 calculates the pointer movement amount as zero (Step S36), and the sending module sends the pointer movement amount (=0) and the click bit to the OS 503 (Step S37).

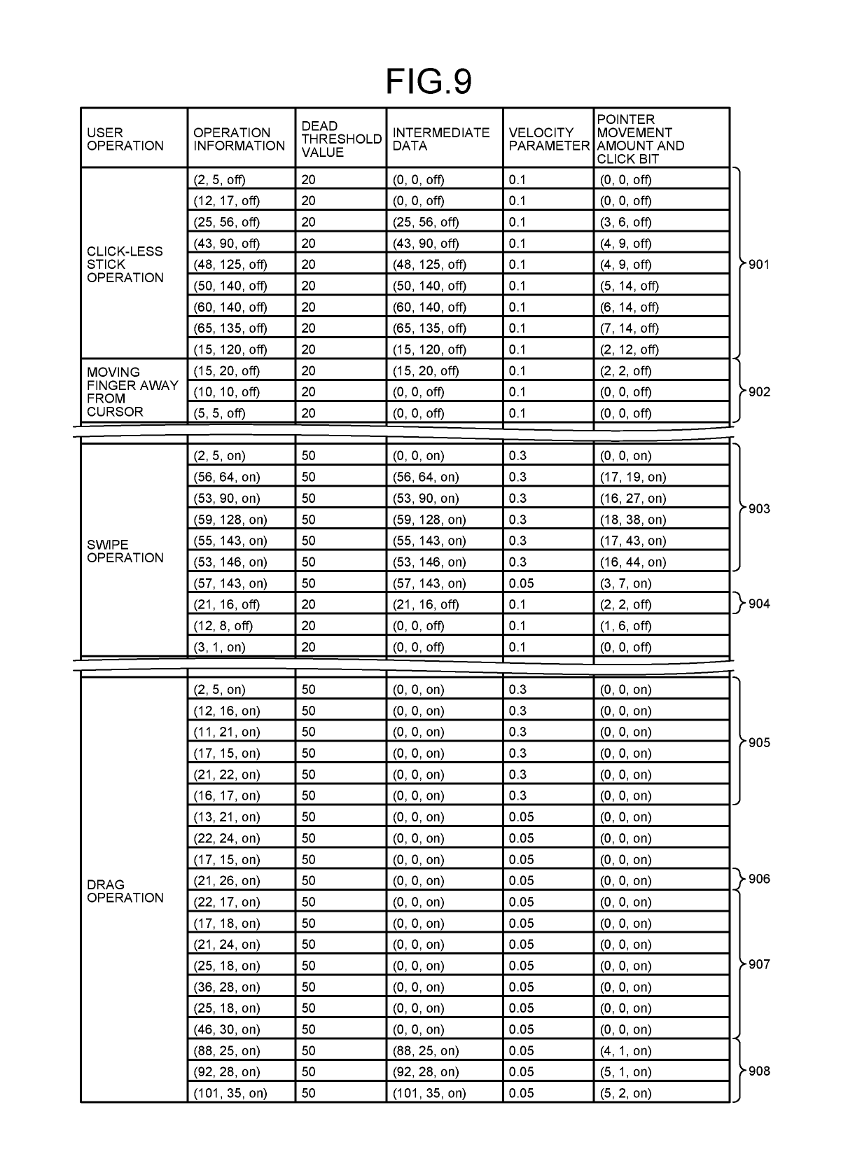

FIG. 9 is a diagram illustrating an example of the relationship among the operation information, the dead threshold value, intermediate data, and the pointer movement amount and click bit according to the first embodiment. In FIG. 9, the first dead threshold value is set to 50 while the second dead threshold value is set to 20. Moreover, in FIG. 9, the first velocity parameter is set to 0.3, the second velocity parameter is set to 0.05, and the third velocity parameter is set to 0.1. Furthermore, the intermediate data is defined to be data containing the pair of the click bit and the movement amount when changed to zero since the movement amount is smaller than the first or second dead threshold value.

In FIG. 9, the area indicated by a reference numeral 901 represents execution of a stick operation with no clicks with the remote controller 150. The area indicated by a reference numeral 902 represents a user's releasing the finger from the stick 211 of the remote controller 150. The areas indicated by reference numerals 903 and 904 represent execution of a swipe operation. In the area indicated by the reference numeral 903, a click of the stick 211 is regarded as start of a swipe operation, and when the stick 211 is moved, a stick operation is identified. In the area indicated by the reference numeral 903, the calculator 513 calculates the pointer movement amount using the first velocity parameter (0.3). As a result, the velocity of the pointer movement becomes fastest. After the area indicated by the reference numeral 903 (the elapse of the predetermined period of time), the calculator 513 identifies the termination of the swipe operation and calculates the pointer movement amount using the second velocity parameter (0.05). When the user stops clicking the stick 211 at the position of the reference numeral 904, the calculator 513 regards the stop as a motion of the cursor with no clicks, calculates the pointer movement amount using the third velocity parameter (0.1), and returns the pointer movement amount to the original value.

Moreover, reference numerals 905 to 908 indicate the data during the execution of a drag operation. That is, in the area indicated by the reference numeral 905, a user's click operation to the stick 211 is regarded as a start of a swipe operation. However, since the operation data is smaller than the first dead threshold value, the calculator 513 sets the pointer movement amount to zero. After the area indicated by the reference numeral 905 (after the elapse of the predetermined period of time), the calculator 513 identifies a drag operation. However, since the operation data is smaller than the first dead threshold value in the area indicated by the reference numerals 906 and 907, the calculator 513 maintains the pointer movement amount at zero. When the operation data exceeds the first dead threshold value in the area indicated by the reference numeral 908, the calculator 513 identifies a drag operation and calculates the pointer movement amount using the second velocity parameter (0.05).

Thus, in the first embodiment, when having determined that the operation data is equal to or greater the first dead threshold value and that the predetermined period of time has not elapsed since the determination of the ON of the click bit in the previously received operation information, the mouse driver 504 determines the execution of a swipe operation with the stick 211 of the remote controller 150. In the swipe operation, the mouse driver 504 changes the pointer movement amount to a faster velocity than that in the drag operation or stick operation. Because of this, in the first embodiment, even with use of the remote controller 150 including the stick 211, a swipe operation can be implemented at an increased pointer moving speed from a slow moving speed and a small pointer movement amount by the drag operation.

In the first embodiment, after the elapse of the predetermined period of time since the time at which the click bit in the previously received operation information is determined to be ON, the mouse driver 504 sets a reduced pointer movement amount for the drag operation. Hence, in the first embodiment, even with use of the remote controller 150 including the stick 211, the drag operation can be more reliably implemented.

### Second Embodiment

In a second embodiment, the mouse driver 504 divides the operation information received from the remote controller 150 to increase a simulated sampling count.

The configuration of the remote controller 150 according to the second embodiment as well as the overall configuration of the television broadcast display device 100 are identical to those in the first embodiment. In the second embodiment, the operation information on the remote controller 150 is also sent to the television broadcast display device 100 via infrared communication. However, in the second embodiment, the speed of the infrared communication is lower than those of other modes of communication.

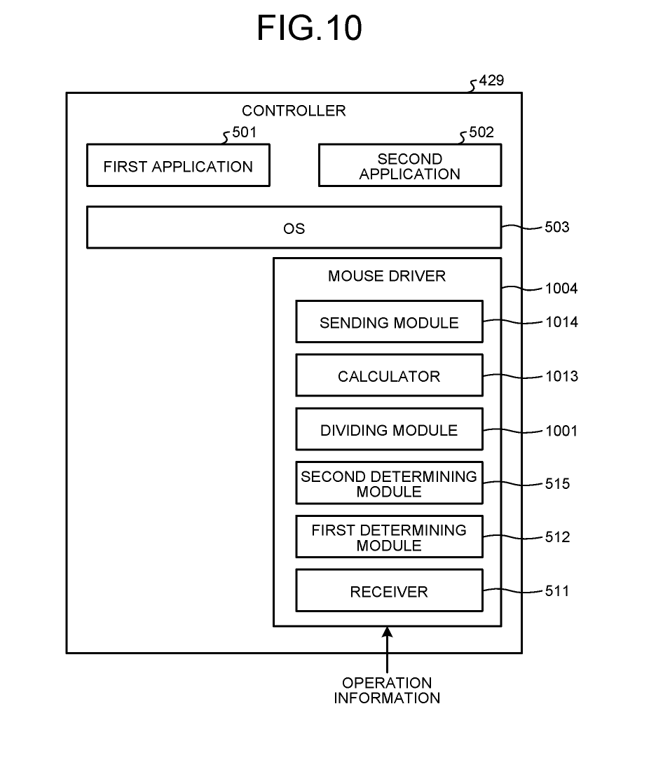

As illustrated in FIG. 10, the controller 427 according to the second embodiment implements the first application 501, the second application 502, the operating system 503, and a mouse driver 1004. Herein, the first application 501, the second application 502, and the operating system 503 have identical functions to those in the first embodiment.

The mouse driver 1004 receives the operation information from the light receiver 429 and transfers that to the OS 503 as the pointer movement amount or the click operation of the cursor 111. As illustrated in FIG. 10, the mouse driver 1004 includes the receiver 511, the first determining module 512, the second determining module 515, a calculator 1013, a sending module 1014, and a dividing module 1001. Herein, the receiver 511, the first determining module 512, and the second determining module 515 identical to those in the first embodiment.

Upon every receipt of the operation information from the receiver 511 at the regular time interval, the dividing module 1001 divides the operation information into a predetermined number n-sets of divided data. Moreover, based on the predetermined number and the operation data, the dividing module 1001 calculates, from the operation data (the amount of movement in the x-axis direction and the amount of movement in the y-axis direction) included in the received operation information, second operation data that indicates the amount of movement in the x-axis direction and the amount of movement in the y-axis direction (a second amount of movement in the x-axis direction and a second amount of movement in the y-axis direction) in the n-sets of divided data. Herein, the second operation data may differ or be the same for the n-sets of divided data. In the second embodiment, the dividing module 1001 divides the operation data by the predetermined number of sets, that is, equally divides the operation data into the n-sets to calculate the second operation data that is smaller than the operation data, and sets the second operation data in each set of divided data. Moreover, as described later, a pointer movement amount based on the second operation data is sent to the OS 503 at time intervals which correspond to equal divisions of the regular time interval. In other words, in the second embodiment, regarding the operation information obtained at the regular time interval, the operation data and the regular time interval are evenly divided to linearly interpolate sampling points.

Moreover, the dividing module 1001 copies the click bit from the operation information to each set of divided data.

The calculator 1013 calculates the pointer movement amount based on the second operation data calculated by the dividing module 1001. More particularly, for each set of divided data, the calculator 1013 multiplies the second operation data (the second amount of movement in the x-axis direction and the second amount of movement in the y-axis direction) by a predetermined velocity parameter to calculate the pointer movement amount (the pointer movement amount in the x-direction and the pointer movement amount in the y-direction).

The sending module 1014 sends, for each set of divided data, a pair of the pointer movement amount (the pointer movement amount in the x-axis direction and the point movement amount in the y-axis direction) calculated by the calculator 513 and the click bit at a timing which matches the time intervals obtained by dividing the regular time interval as the interval of reception of the operation information by the predetermined number n.

Thus, in the second embodiment, the mouse driver 1004 divides the operation information received at the regular time interval into the n-sets of divided data, and sequentially sends the pointer movement amount (the pointer movement amount in the x-axis direction and the pointer movement amount in the y-axis direction) and the click bit to the OS 503 at the time intervals as the divided regular time intervals corresponding to the sets of divided data. Thereby, the cursor 111 is controlled under the OS 503, the first application 501, or the second application 502 at a shorter time interval than the regular time interval representing the reception interval of the operation information. This signifies a simulated increase in the sampling count of the operation information to the number n.

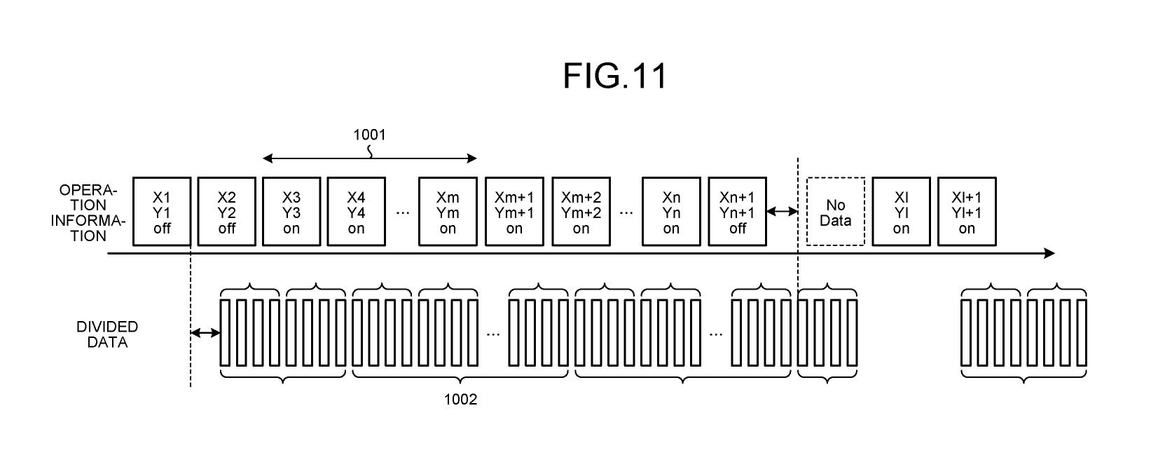

FIG. 11 illustrates an example of the operation information and the divided data according to the second embodiment. FIG. 11 illustrates an example of the predetermined number n=4. As illustrated in FIG. 11, the receiver 511 receives, at the regular time interval, the operation information on the stick 211 containing the amount of movement in the X-axis direction (for example, x1, x2, . . . ), the amount of movement in the Y-axis direction (for example, y1, y2, . . . ), and a click bit in association with one another. Then, the dividing module 1001 divides the operation information into four sets of divided data as illustrated in FIG. 11. In the operation information illustrated in FIG. 11, for example, the area indicated by a reference numeral 1101 represents a swipe operation. The operation information in this area is divided into four sets of divided data as indicated by a reference numeral 1102. The calculator 1013 calculates the second operation data for each set of divided data as one-fourth of the operation data (for example, x1/4 of x1, y1/4 of y1) and sets the calculated second operation data in the divided data. The click bit in the original operation information is copied to each set of divided data.

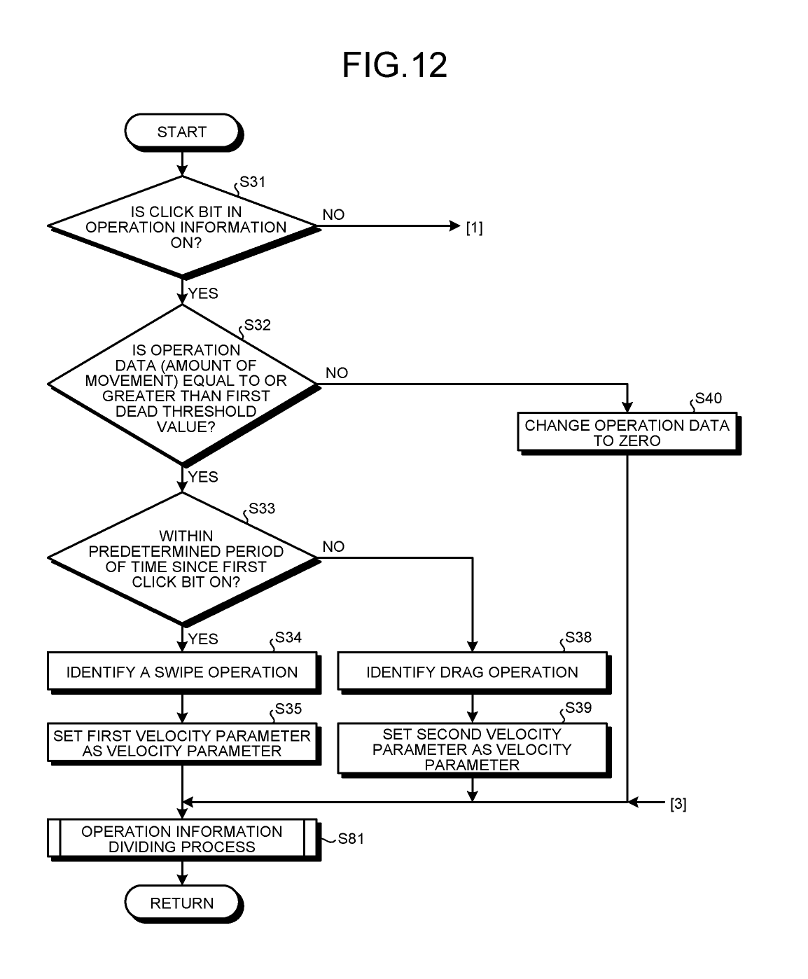

Explained below with reference to FIG. 12 is an operation control process by the mouse driver 1004 as configured above according to the second embodiment. Every time the receiver 511 of the mouse driver 1004 receives operation information from the remote controller 150 at the regular time interval, the processing illustrated in FIG. 12 is performed.

Herein, the operations from Step S31 to Step S40 excluding Steps S36 and S37 are performed in the same manner as in the first embodiment. After the velocity parameter is set, the dividing module 1001 divides the operation information (Step S81). This completes the process.

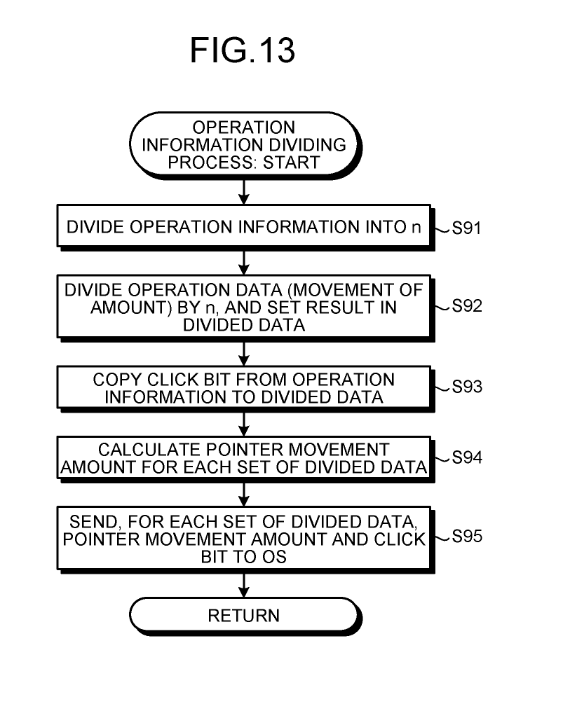

FIG. 13 is a flowchart of an exemplary sequence of the operation information dividing process according to the second embodiment. Firstly, the dividing module 1001 generates the predetermined n-sets of divided data by dividing the received operation information (Step S91). Then, the dividing module 1001 divides, by the number n, each of the amounts of movement in the x-axis direction and in the y-axis direction as the operation data contained in the operation information and sets the obtained value for the amount of movement of each set of divided data as the second operation data (the second amount of movement in the x-axis direction and the second amount of movement in the y-axis direction) (Step S92).

Then, the dividing module 1001 copies the click bits from the operation information to the respective n-sets of divided data (Step S93).

Subsequently, for each set of divided data, the calculator 1013 multiplies the second operation data (the second movement amount in the x-axis direction and the second movement amount in the y-axis direction) by the predetermined velocity parameter to calculate the pointer movement amount (the pointer movement amount in the x-axis direction and the pointer movement amount in the y-axis direction) (Step S94).

Then, the sending module 1014 sequentially sends, to the OS 503, the pointer movement amounts calculated at Step S94 and the click bits for the respective sets of divided data at the time interval as 1/n of the regular time interval (Step S95). As a result, the OS 503 controls the display of the pointer according to the received pointer movement amounts and the click bits. Thus, in all of the operations including a drag operation, a stick operation, and a swipe operation, the sampling count increases in a simulated manner.

As described above, in the second embodiment, the mouse driver 504 receives the operation information at the regular time interval from the remote controller 150, divides it into the predetermined number of sets of divided data, sets a smaller amount of movement as the second operation data for each set of divided data, and sends, to the OS 503, the pointer movement amount (the pointer movement amount in the x-axis direction and the pointer movement amount in the y-axis direction) based on the divided second operation data and the click bit at the time interval as the divided regular time interval by the predetermined number. Hence, according to second embodiment as in the first embodiment, even with a simulated increase in the sampling count of the operation information, even at a slow moving speed of the pointer, the swipe operation can be implemented with the pointer moving at an increased speed. Moreover, even when the operation information is sent from the remote controller 150 to the television broadcast display device 100 via lower-speed infrared communication, the cursor 111 (the pointer) can be smoothly moved.

Meanwhile, in the second embodiment, regarding the operation information, the dividing module 1001 evenly divides the operation data and the regular time interval by the predetermined number n and increases the sampling points by linear interpolation. However, it should not be limited thereto. Alternatively, for example, regarding the operation information, the dividing module 1001 can be configured to differently divide the operation data (the amount of movement) and the regular time interval to interpolate the sampling points. Examples of such an interpolation method include Bezier interpolation.

Moreover, in the second embodiment, the division of the operation information, the calculation of the second operation data and the pointer movement amount are performed by the mouse driver 1004. However, alternatively, the mouse driver 1004 and the OS 503 can be configured in such a manner that some or all operations are performed by the OS 503.

Furthermore, in the second embodiment, the click bit is set to ON when the stick 211 of the remote controller is clicked, and the click bit is set to OFF when the stick 211 is not clicked, and the click bit is sent to the television broadcast display device 100. In the television broadcast display device 100, the mouse driver 1004 or the OS 503 determines whether or not the stick 211 is clicked from the on/off status of the click bit. However, it should not be limited thereto. Alternatively, for example, when the stick 211 of the remote controller 150 is clicked, the click bit (=ON) is sent to the television broadcast display device 100. With no click on the stick 211, the click bit is not sent to the television broadcast display device 100. Thus, in the television broadcast display device 100, the mouse driver 1004 or the OS 503 can determine whether or not the stick 211 is clicked from receipt or no receipt of the click bit.

Further, the above embodiments have described the example of the communication between the television broadcast display device 100 and the remote controller 150 via infrared communication. However, the communication is not limited to infrared communication, and wireless communication such as Bluetooth (registered trademark) can be alternatively used.

An operation control program executed in the television broadcast display device 100 according to the embodiments is stored in advance in the memory 431 such as a ROM, and is provided as a computer program product.

The operation control program executed in the television broadcast display device 100 according to the embodiments can be recorded as an installable or executable file format on a computer-readable recording medium such as a CD-ROM, a flexible disk (FD), or a DVD (Digital versatile Disk); and can be provided as a computer program product.

Further, the operation control program executed in the television broadcast display device 100 according to the embodiments can be stored in a computer connected to a network such as the Internet, downloaded via the network, and provided as a computer program product. Also, the operation control program executed in the television broadcast display device 100 according to the embodiments can be provided or distributed as a computer program product via a network such as the Internet.

The operation control program executed in the television broadcast display device 100 according to the embodiments has a configuration including the modules of the mouse driver 504 (the receiver 511, the first determining module 512, the second determining module 515, the calculator 513, the sending module 514, the dividing module 1001, the calculator 1013, and the sending module 1014). As the actual hardware, the CPU reads the operation control program from the memory 431 such as a ROM and executes the operation control program to load the above modules on the memory 431 such as a RAM and generate the receiver 511, the first determining module 512, the second determining module 515, the calculator 513, the sending module 514, the dividing module 1001, the calculator 1013, and the sending module 1014 on the memory 431 such as a RAM.

The various modules of the system mentioned herein can be implemented as software applications, hardware and/or software modules, or components of one or more computers such as servers. Although the various modules are explained separately, they can partially or entirely share the same fundamental logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver that receives operation information at a regular time interval, the operation information including an amount of movement by an operation of an operating module in association with click information, the click information indicating that the operating module is pressed;
a first determining module that determines, when the operating module is pressed based on the click information, whether or not the amount of movement in the received operation information is equal to or greater than a first threshold value;
a second determining module that determines, when the amount of movement is equal to or greater than the first threshold value, whether or not a predetermined period of time elapses from an initial press to the operating module;
a calculator that determines, when the predetermined period of time has elapsed from the initial press to the operating module, that a swipe operation has been performed with the operating module and calculates an amount of movement of a pointer to be a greater value than an amount of movement in a drag operation; and
a controller that controls movement of the pointer based on the calculated amount of movement of the pointer and the click information.

2. The electronic device of claim 1, wherein, after elapse of the predetermined period of time, the calculator returns the amount of movement of the pointer to a value prior to the determination that the swipe operation has been performed.

3. The electronic device of claim 1 or 2, wherein, when the click information in the operation information that is received after the determination that the swipe operation has been performed indicates that the operating module is not pressed, the calculator returns the amount of movement of the pointer to a value prior to the determination that the swipe operation has been performed.

4. The electronic device of any one of claims 1 to 3, further comprising a dividing module that divides the operation information into a predetermined number of sets of divided data and sets a second movement amount in the sets of divided data, the second movement amount based on the predetermined number and the amount of movement, wherein
the calculator calculates the amount of movement of the pointer based on the second movement amount.

5. The electronic device of any one of claims 1 to 4, wherein, when the amount of movement in the received operation information is smaller than the first threshold value, the calculator sets the amount of movement of the pointer to zero.

6. An operation control method comprising:
receiving operation information at a regular time interval, the operation information including an amount of movement by an operation of an operating module in association with click information, the click information indicating that the operating module is pressed;
determining, when the operating module is pressed based on the click information, whether or not the amount of movement in the received operation information is equal to or greater than a first threshold value;
determining, when the amount of movement is equal to or greater than the first threshold value, whether or not a predetermined period of time elapses from an initial press to the operating module;
determining, when the predetermined period of time has elapsed from the initial press to the operating module, that a swipe operation has been performed with the operating module, and calculating an amount of movement of a pointer to be a greater value than an amount of movement in a drag operation; and
controlling movement of the pointer based on the calculated amount of movement of the pointer and the click information.

7. A computer program product including programmed instructions embodied in and stored on a non-transitory computer readable medium, wherein the instructions, when executed by a computer, cause the computer to perform:
receiving operation information at a regular time interval, the operation information including an amount of movement by an operation of an operating module in association with click information, the click information indicating that the operating module is pressed;
determining, when the operating module is pressed based on the click information, whether or not the amount of movement in the received operation information is equal to or greater than a first threshold value;
determining, when the amount of movement is equal to or greater than the first threshold value, whether or not a predetermined period of time elapses from an initial press to the operating module;
determining, when the predetermined period of time has elapsed from the initial press to the operating module, that a swipe operation has been performed with the operating module, and calculating an amount of movement of a pointer to be a greater value than an amount of movement in a drag operation; and
controlling movement of the pointer based on the calculated amount of movement of the pointer and the click information.
